(19) United States
(12) Patent Application Publication
(10) Pub. No.: US 2024/0336066 A1
(43) Pub. Date: Oct. 10, 2024

(54) METHOD AND DEVICE FOR CORRECTING A PRINT TEMPLATE FOR PRINTING ON CONTAINERS

(71) Applicant: Dekron GmbH, Kelkheim (DE)

(72) Inventors: Thomas SPELLUCCI, Eschborn (DE); Klaus EICH, Hofheim (DE); Frank UFER, Idstein (DE)

(21) Appl. No.: 18/627,235

(22) Filed: Apr. 4, 2024

(30) Foreign Application Priority Data
Apr. 6, 2023 (DE) 10 2023 108 939.0

(51) Int. Cl. B41J 2/17; B41J 2/045; B41J 3/407

(52) U.S. Cl. CPC B41J 2/1714; B41J 2/04541; B41J 3/40733

(57) ABSTRACT

Direct printing method for printing on a container having a print image by means of a direct printing device comprising a direct printing head with at least one printing nozzle row and an ink mist extraction unit, wherein a pixel offset is determined for at least one pixel of a print template for the print image based on a model for a print deviation from a normal pressure value caused by the ink mist extraction unit along the printing nozzle row, wherein a corrected print template is generated based on the determined pixel offset, wherein the print image is applied to the container by means of the direct printing device based on the corrected print template.

### CROSS REFERENCE TO RELATED APPLICATION

The present application claims priority to German Patent Application No. 10 2023 108 939.0 filed on Apr. 6, 2023. The entire contents of the above-listed application are hereby incorporated by reference for all purposes.

### TECHNICAL FIELD

The present disclosure relates to methods for correcting a print template for printing on containers along with corresponding devices for correcting a print template for printing on containers.

### BACKGROUND

The correction of a print template to avoid distortion of a print image applied to a container surface based on the print template is known from the prior art.

### SUMMARY

For example, it is known to control the ejection time of ink drops from different printing nozzles of a direct printing device based on a surface shape of the container to be printed on. Thus, compensation for different distances to the container surface can be achieved for various printing nozzles, and the resulting distortion of the print image can be prevented.

DE 10 2017 215 429 A1 discloses a direct printing process for a direct printing machine for printing containers, in particular molded containers, with direct printing. A 3D print model is created from 3D data of the containers, a print movement path of the direct printing machine and print parameters of the direct printing machine, in order to predict an image of a print graphic template to be printed on the containers as a direct print. By means of the 3D print model, a macroscopic correction and a microscopic correction are subsequently determined, wherein the macroscopic correction comprises an inverse of a distortion of the print graphic template on the containers and the microscopic correction comprises a nozzle correction. The print graphic template is then corrected with the macroscopic correction and stored in a corrected print graphic, wherein a raster image processor is used to generate a print raster image from the corrected print graphic. The print screen image is subsequently corrected on the basis of the microscopic correction and stored as a corrected print screen image and printed as a direct print on the containers using the direct printing machine.

The methods known from the prior art enable the correction of a print template to compensate for certain effects that cause distortions in the print image. However, other effects that are also responsible for distortion of the print image are not addressed in the known prior art, so that distortions of the print image may remain.

### Object

Based on the prior art, the task to be achieved by the present disclosure is to provide a method and a device for correcting a print template in order to compensate for undesirable distortions of a print image applied to a container surface caused by various interference effects.

### Achievement

The task is achieved according to the disclosure by the methods for correcting a print template for printing on containers and the corresponding devices for correcting a print template for printing on containers.

With the direct printing method according to the disclosure for printing on a container having a print image by means of a direct printing device comprising a direct printing head with at least one printing nozzle row and an ink mist extraction unit, a pixel offset is determined for at least one pixel of a print template for the print image based on a model for a print deviation from a normal pressure value caused by the ink mist extraction unit along the printing nozzle row, a corrected print template is generated based on the determined pixel offset and the print image is applied to the container by means of the direct printing device based on the corrected print template.

With this method, containers of various types, optionally bottles made of glass, plastic or materials containing fibers used in the beverage industry, can be printed on. However, the method is not limited to the type of container just mentioned and can also be designed, for example, to print on cups, glasses, cans or tubes, such as those used in the beverage, pharmaceutical, healthcare or food industries, or any other container that is suitable for holding a liquid or pasty medium.

The pressure value can be understood, for example, as a position (coordinate) of a print dot applied to the container surface by means of a printing nozzle of the direct printing device. Alternatively, a pressure value can also be understood as a pressure applied to a printing nozzle of the direct printing device (air pressure value).

The normal pressure value is to be understood as a reference pressure value, wherein it can be a printing position of a print dot applied by one of the printing nozzles of the direct printing device without ink mist extraction (or with ink mist extraction switched off) on a reference surface (for example, a container surface). The normal pressure value can, for example, be described by normal pressure value coordinates. In one embodiment, it can be provided that the normal pressure values for the printing nozzles of a printing nozzle row or the printing nozzles of the direct printing head are described by a normal pressure value function, by means of which an assigned normal pressure value can be determined for any printing nozzle position of the printing nozzle row or the direct printing head. Alternatively, the normal pressure value can also be a normal air pressure applied to a printing nozzle of the printing nozzle row without ink mist extraction (or with ink mist extraction switched off).

The print template can be understood, for example, as a raster image of the print image that is to be applied to the container surface by means of the direct printing device. The raster image can, for example, be generated by means of a raster process based on the print image, wherein the print image itself can be available as a raster print image or vector print image.

The ink mist extraction unit is to be understood as an extraction device that can extract the ink mist, generated by the direct printing device during printing, from a print region and thus prevent contamination of the direct printing device or the container surface by the ink mist. The ink mist comprises ink mist drops, which may have a significantly smaller volume than the ink drops ejected by the printing nozzles, to generate the print image. A significantly smaller volume is to be understood as a volume that is, for example, at least one order of magnitude smaller than the volume of the ink drops intended to generate the print image.

In particular, the model is to be understood as a mathematical relationship that assigns to at least one of the printing nozzles of the direct printing head, and thus to at least one of the pixels of the print template, a print deviation, caused by the ink mist extraction, of a corresponding print dot applied to the container surface from a normal pressure value. The print deviation can be a relative displacement Ax of the print dot (or its position or coordinate) with respect to the normal pressure value x (or the normal printing position or normal print coordinate). For example, the relative displacement can be a vector. If the displacement takes place along a specific direction, it is also possible for the relative displacement to be a scalar. For example, the mathematical relationship can be a print deviation function, based on which a corresponding print deviation of a print dot applied to the container surface from a normal pressure value can be determined for a specific printing nozzle coordinate. Alternatively, if the pressure value is an air pressure value, the model can also describe a mathematical relationship that assigns an air print deviation from a normal air pressure value caused by the ink mist extraction to at least one of the printing nozzles of the direct printing head. A pixel offset and/or the corrected print template can then be ascertained from this.

Thus, based on the model of the print deviation caused by the pressure extraction of a print dot applied to the container surface (or its coordinate or position) from a normal pressure value or an air print deviation, caused at a printing nozzle, from a normal air pressure value, and the pixel offset determined from this, a deflection of the trajectory of the ink drops ejected by the direct printing device caused by the ink mist extraction and an associated distortion of the print image can be corrected and a high-quality print layer can be generated on the container surface.

In one embodiment, the model of the print deviation is determined based on a maximum print deviation at one position of the printing nozzle row from the normal pressure value, a first print deviation from the normal pressure value at a first printing nozzle arranged at one end of the printing nozzle row and a second print deviation from the normal pressure value at a second printing nozzle arranged at the other end of the printing nozzle row. Maximum print deviation refers to the print deviation with the largest value of all print deviations. A printing nozzle arranged at one end of the printing nozzle row is to be understood as one of the two outermost printing nozzles of a printing nozzle row, i.e., a printing nozzle that has only a single neighbor. In one embodiment, however, it can also be provided that one end refers to an outer region of the printing nozzle row, which can comprise a certain number, such as three or five, of printing nozzles arranged at one end of the printing nozzle row. Since only three parameters are required for modeling, the model of the print deviation can be determined in a particularly efficient way. In particular, it is not necessary to determine the print deviations along each of the printing nozzles of the printing nozzle rows.

In a further development of this embodiment, in the event that the maximum print deviation is at a position between the first printing nozzle and the second printing nozzle, the print deviation along the printing nozzle row is determined in a first region of the printing nozzle row by linear interpolation between the first print deviation and the maximum print deviation and in a second region of the printing nozzle row by linear interpolation between the second print deviation and the maximum print deviation. By dividing the print deviation into two regions and by linear interpolation between the first print deviation and the maximum print deviation as well as between the second print deviation and the maximum print deviation, the actual print deviation along the printing nozzle can be approximated with sufficient precision.

In a further development of one of the preceding embodiments, the pixel offset is determined based on the model of the print deviation for at least one pixel line of the print template. This enables a particularly time-efficient determination of the pixel offset, since the pixel offset does not have to be determined individually for each pixel position.

According to the disclosure, there is also provided a direct printing device for printing on a container, wherein the direct printing device comprises a direct printing head having a plurality of printing nozzles, an ink mist extraction unit and a control unit, wherein the printing nozzles are arranged in at least one printing nozzle row and the control unit is designed to carry out the method according to one of the preceding embodiments.

Based on the pixel offset determined using the model of the print deviation from a normal pressure value and the correspondingly corrected print template, a distortion-free and high-quality print image can be applied to the container surface by the direct printing device according to the disclosure and thus compensation can be achieved for the offset of print dots caused by the ink mist extraction unit.

In a further development of this embodiment, the ink mist extraction unit is arranged on a side surface of the direct printing head. Through this type of arrangement of the ink mist extraction unit, the ink mist can be particularly efficiently extracted, and the trajectory of the ink drops ejected through the printing nozzle openings can be minimally influenced.

In a further direct printing method according to the disclosure for printing on an irregular container, at least one pixel line with a pixel number n of a print template for a print image based on a shape of a surface region of the irregular container is extended by a pixel number m and the information contained in the original pixel line is scaled to the extended pixel line, wherein a corrected print template is generated based on the at least one extended pixel line and the print image is applied to the surface region of the irregular container by means of a direct printing device having a plurality of printing nozzles based on the corrected print template.

A pixel line is to be understood as a row of pixels arranged along any direction in the print template. The pixel line may be a row of pixels arranged along either a horizontal or a vertical direction in the print template.

An irregular container is to be understood as a container whose surface deviates from an ideal shape, for example an ideal cylindrical shape. This includes, for example, a container whose surface is at least partially conical in shape, such as a container with a cylindrical base body and a conical shoulder region. In addition, containers provided with embossing or debossing can also be classified as irregular containers.

The shape of the surface region is to be understood as a three-dimensional structure of the surface region to which the print image is to be applied. The shape of the surface region can, for example, be described by a plurality of surface coordinates and deviate from the ideal shape for an irregular container.

By extending a pixel line based on a shape of a surface region of the irregular container and generating a corrected print template, compensation can be achieved for distortions in the print image caused by the irregular surface of the container and the quality of the applied print image can be increased.

In one embodiment, the scaling of the information contained in the original pixel line to the extended pixel line comprises an interpolation between two adjacent pixels of the original pixel line. Thus, the pixel line of the print template can be extended relatively easily without the quality of the print image being adversely affected by the scaling.

A further direct printing device according to the disclosure for printing on an irregular container comprises a direct printing head having a plurality of printing nozzles, wherein the printing nozzles are arranged in at least one printing nozzle row, and a control unit, wherein the control unit is designed to carry out the method according to one of the preceding embodiments of the direct printing method for printing on the irregular container.

Based on the corrected print template which is generated based on the extended pixel line, a high-quality print image, which in particular does not have any distortions caused by the irregular container surface, can be applied to the container surface by the direct printing device.

With a further direct printing method according to the disclosure for printing on a container, a pixel offset is determined for at least one pixel of a print template for a print image based on an offset of a first printing nozzle arranged on one side of a direct printing head comprising printing nozzles and a second printing nozzle arranged on an opposite side of the direct printing head with respect to a print plane, wherein a corrected print template is generated based on the determined pixel offset, wherein the print image is applied to the container by means of the direct printing device based on the corrected print template.

The print plane is to be understood as a plane that, in the case of a specific standard alignment of the direct printing head with respect to a surface to be printed on, either runs exactly parallel to the directions along which a first ink drop is ejected through the first printing nozzle and a second ink drop through the second printing nozzle of the direct printing head, or is exactly perpendicular to these two directions. Therefore, an offset between the first and second printing nozzles and the print plane only exists if the printing head is rotated or tilted with respect to its specific standard alignment.

Based on the offset, a pixel offset can thus be determined for at least one pixel of the print template and a corrected print template can be generated based on the pixel offset. By means of the corrected print template, a printing error caused by tilting or rotating of the printing head can thus be corrected, thereby improving the quality of the print image applied to the container surface.

In a further embodiment, the printing nozzles of the direct printing head can be arranged in at least one printing nozzle row and the pixel offset can be determined based on an offset of a first printing nozzle arranged at one end of a printing nozzle row and a second printing nozzle arranged at the other end of the printing nozzle row with respect to the print plane and/or the pixel offset can be determined based on an offset between a first printing nozzle of a first printing nozzle row arranged at one end of the direct printing head and a second printing nozzle of a second printing nozzle row arranged at the other end of the direct printing head with respect to the print plane. Since the offset with respect to the print plane is greatest in these regions of the direct printing head, the accuracy of the determined pixel offset can be increased and thus the quality of the corrected print image can be further improved.

In a further development of one of the two preceding embodiments, the pixel offset is determined based on the maximum number of printing nozzles of the direct printing head and the position of the pixel. The use of these additional parameters makes it possible to determine the pixel offset as exactly as possible and thus to correct the print image as precisely as possible.

According to the disclosure, a direct printing device for printing on a container is further provided, wherein the direct printing device comprises a direct printing head having a plurality of printing nozzles and a control unit, wherein the printing nozzles are arranged in at least one printing nozzle row and the control unit is designed to carry out the method for printing on a container according to one of the three preceding embodiments.

Thus, the direct printing device can compensate for a pixel offset caused by tilting or rotating and ensure that a high-quality print image is applied to the container surface.

In one embodiment of one of the direct printing methods discussed above, it can be provided that the print template is divided into different color layers and a corrected print template is created for each color layer. This also enables a distortion-free application of colored print images.

### BRIEF DESCRIPTION OF FIGURES

FIGS. 1a and b: Method for determining a pixel offset for correcting a print deviation caused by an ink mist extraction unit according to one embodiment

FIG. 2: Method for pixel extension for correcting an irregular container surface according to one embodiment

FIG. 3: Method for correcting a print template in the event of misalignment of a direct printing head

### DETAILED DESCRIPTION OF FIGURES

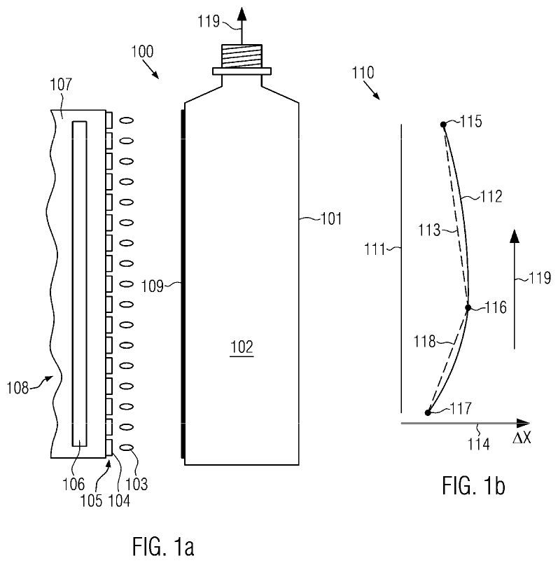

FIGS. 1a and b show a printing device 100, and a print image applied to a container surface by the printing device 100, along with a model of a print deviation 110 caused by an ink mist extraction of the direct printing device according to one embodiment.

According to the disclosure, it is provided to determine a pixel offset for at least one pixel of a print template based on the model for the print deviation from a normal pressure value 111 caused by the ink mist extraction 113, 118 along a printing nozzle row 105 of a direct printing head 107 of a direct printing device 108.

Using the determined pixel offset, a corrected print template can be generated, wherein, in the corrected print template, compensation is achieved for an offset of the print dots of the print image caused by the ink mist extraction unit 106 and, based on the corrected print template, a distortion-free print image can be applied to a surface 101 of a container 102.

The container 102 is optionally a bottle made of glass, plastic or material comprising fibers used in the beverage industry. Alternatively, it can also be, for example, a cup, a glass, a can or a tube, such as those used in the beverage, pharmaceutical, healthcare or food industries, or any other container suitable for holding a liquid or pasty medium.

As illustrated in connection with FIG. 1a, the direct printing device 108 can comprise a direct printing head 107 having a plurality of printing nozzles 104, wherein the printing nozzles are arranged along a printing nozzle row 105 and are designed to eject ink drops 103. The direct printing device 108 can comprise a control unit, not shown here, which is designed to control the printing nozzles 104 of the direct printing device 108 based on a print template and to generate a print image 109 on a surface 101 of a container 102. In the embodiment shown here, the printing nozzle row 105 is aligned parallel with respect to a longitudinal container axis 119, so that a print line 109 applied to the container surface 101 by the printing nozzle row 105 runs exactly parallel to the longitudinal container axis 119. However, this alignment between printing nozzle row 105 and the longitudinal container axis 119 is to be understood as exemplary. The printing nozzle row 105 can also be positioned at an angle α with respect to the longitudinal container axis 119, for example, as a result of which the print resolution can be increased when applying a print image along the circumference of the container.

In order to apply a print image along the circumference of the container 102 on its surface 101, the container can, in one embodiment, be mounted rotatably about the container longitudinal axis 119 with respect to the direct printing device 108. For this purpose, the container 102 can be arranged on a turntable, for example, by means of which the container can be rotated about its longitudinal axis 119. The turntable can be driven by a servo motor, for example. For example, it can also be provided that the turntable is a container holder of a rotary machine of a container treatment system and the direct printing device 108 is arranged so as to be stationary along the periphery of the rotary machine. Alternatively, it can also be provided that the direct printing device 108 is assigned to the container holder. In a further alternative embodiment, it can be provided that the direct printing device 108 is arranged movably with respect to the container surface 101 and can be moved around the container surface 101 to apply the print image 109.

The direct printing device 108 can be designed to print different types of colors, such as white color, CMYK colors, varnish colors and spot colors. The inks may be UV printing inks, although printing inks of any other type can also be used. The direct printing device can optionally comprise a curing unit with a light source for emitting UV radiation. Other types of light sources, such as a light source operating in the visible wavelength range, are also conceivable. In particular, the light source can be selected based on the ink printed by the direct printing device.

The direct printing device 108 can further comprise an ink mist extraction unit 106, which can be arranged on a side surface of the direct printing head 107. By means of the ink mist extraction unit 106, the ink mist generated by the direct printing device during the printing process can be extracted from the print region, thus preventing contamination of the container surface 101, the applied print image 109 and also the direct printing device 108 itself. If the ink mist extraction unit 106 is arranged on a side surface of the direct printing head 107, efficient extraction of the ink mist generated by the direct printing device 108 can be achieved and at the same time the trajectory of the ink drops 103 ejected by the printing nozzles can be influenced as little as possible.

Since, as just described, the air flow generated by the ink mist extraction unit 106 not only causes extraction of the ink mist generated by the direct printing device 108, but also influences the trajectory of the ink drops 103 ejected from the printing nozzle openings of the direct printing device 108, an undesired displacement of the point of impact of an ink drop 103 on the container surface 101 can occur during operation of the ink mist extraction unit 106. This in turn leads to a distortion of the print image 109 applied to the container surface 101 compared to the intended print image and to a deterioration in the print quality.

In order to compensate for this effect, the method according to the disclosure provides for determining a pixel offset for at least one pixel of a print template based on a model for a print deviation caused by an ink mist extraction unit and for generating a corrected print template based on the determined pixel offset. Based on the corrected print template, in which the displacement of the print dots caused by the ink mist extraction unit 106 is taken into account, a distortion-free print image 109 can then be applied to the container surface 101.

As described above, the direct printing device 108 can comprise a control unit for performing the method, wherein the control unit can comprise, for example, a computing unit (processor) and a volatile or non-volatile memory. For example, the print image and/or the print template can be stored in the memory of the control unit. Furthermore, the model of the print deviation from a normal value caused by the ink mist extraction unit 106 can be stored in the memory of the control unit. In one embodiment, a plurality of models can also be stored in the memory unit, wherein each of the models can be assigned to a particular operating stage of the ink mist extraction unit 106. For example, it can be provided that the ink mist extraction unit 106 can be operated in a plurality of (for example, five) different operating stages, wherein the different operating stages can be assigned different extraction capacities. Consequently, a model of the print deviation can be stored in the memory of the control unit for each of the operating stages of the ink mist extraction unit 106.

The control unit can also exchange data with the ink mist extraction unit 106, so that the control unit can automatically load a corresponding model of the print deviation from the memory based on the operating stage of the ink mist extraction unit 106.

In particular, the control unit can be designed, as already described above, to determine the pixel offset for at least one pixel of a print template based on the print model and to generate a corrected print template based on the pixel offset and to control the direct printing device 108 based on the corrected print template, so that a print image 109 is generated on the container surface 101, with which the displacement of the print dots caused by the ink mist extraction unit 106 is corrected. Thus, a high-quality and in particular distortion-free print image 109 can be generated on the container surface 101.

The design of the direct printing device 108 described in connection with FIG. 1a is to be understood as exemplary. In particular, the direct printing head 107 can also comprise any other number of printing nozzles 104 and the printing nozzles 104 can also be arranged in more than one printing nozzle row 105. The design and arrangement of the ink mist extraction unit 106 discussed in this connection is also not to be understood as limiting. In an alternative embodiment, the ink mist extraction unit 106 can also be arranged above or below the printing nozzle row, for example, or at any other position suitable for extracting the ink mist generated by the direct printing device 108.

The print model for a print deviation from a normal pressure value along a printing nozzle row caused by the ink mist extraction unit 106 is explained in more detail below in connection with the print image 110 shown in FIG. 1b, comprising a first 111 and second print line 112.

The first print line 111 (normal pressure value line) shown in FIG. 1b comprises a plurality of normal pressure values, which may, for example, have been applied to the surface 101 of the container 102 by the printing nozzle row 105 of the direct printing head 107 shown in connection with FIG. 1a. The print line 111 represents a print line that was applied to the surface 101 of the container 102 with a deactivated (switched off) ink extraction unit. As described in connection with FIG. 1a, the printing nozzle row 105 can be aligned parallel with respect to the longitudinal container axis 119. In this case, the first print line 111 shown in FIG. 1b is also aligned parallel with respect to the longitudinal container axis. In an alternative embodiment, in which the printing nozzle row 105 is positioned at any angle of incidence with respect to the longitudinal container axis 119, the first print line 111 can also be positioned at any angle of incidence with respect to the longitudinal axis 119 of the container 102.

Also shown is a second print line 112 (print deviation) having a plurality of print deviation values. The second print line 112 can also have been applied to the container surface 101 using the printing nozzle row of the direct printing head described in connection with FIG. 1a, but with an ink mist extraction unit activated.

Between the application of the first print line 111 shown in FIG. 1b and the second print line 112, there was no relative movement between the direct printing head 107 and the container surface 101, so that a relative displacement Ax 114 between the two print lines is caused solely by the influence of the ink mist extraction unit 106. The relative displacement Ax 114 depends on the position of the printing nozzle position, by means of which a print dot of the second print line assigned to a specific displacement Ax was applied.

Also shown is the model of the print deviation 113, 118 which represents an approximation of the second print line 112.

In one embodiment, to determine the model of the print deviation, it can be provided to determine the print deviation based on a maximum print deviation 116 at a position of the printing nozzle row from the normal pressure value 111, a first print deviation 115 from the normal pressure value 111 at a first printing nozzle arranged at one end of the printing nozzle row and a second print deviation 117 from the normal pressure value 111 at a second printing nozzle arranged at the other end of the printing nozzle row. Here, maximum deviation is to be understood as the maximum displacement Ax 114 of a print dot 116 of the second print line 112 with respect to the corresponding normal pressure value of the first print line 111.

In the embodiment described in connection with FIG. 1b, the maximum deviation is present at the print dot 116 and thus at the position of the printing nozzle row or the corresponding printing nozzle through which the print dot 116 was generated. Furthermore, the print dots 115 and 117 correspond to the print dots generated by the printing nozzles 105 arranged at the two outermost ends of the printing nozzle row 105 shown in connection with FIG. 1a and are added as first print deviation 115 and second print deviation 117 to determine the model of the print deviation in accordance with the embodiment described above. For reasons of clarity, the three print dots 115, 116 and 117 are only shown as thicker dots in FIG. 1b.

In one embodiment, it can be provided that the model of the print deviation in a first print region is determined by linear interpolation 113 between the first print deviation 115 and the maximum print deviation 116 and in a second print region is determined by linear interpolation between the second print deviation 117 and the maximum print deviation 116. This makes it particularly easy to determine the model of the print deviation, since no complicated and computationally intensive methods are required to determine the model of the print deviation. This takes into account the fact that a pixel offset in a printing head is only possible in integer multiples of the pixel size and/or of the distance between the nozzles of a nozzle row. This discrete subdivision is sufficiently large to achieve an improvement in the printing result when using linear interpolation.

Based on the model of the print deviation, the control unit can then determine a pixel offset for at least one pixel of the print template and generate a corrected print template based on the pixel offset. Based on the corrected print template, the print image 109 can subsequently be applied to the container surface 101 by the direct printing device 108.

In one embodiment, it can be provided that the control unit comprise a recognition device, such as a camera, and is designed to determine the print model.

For this purpose, it can be provided that in a first print pass on a test container, a first print line 111 with at least one normal pressure value be applied to the container surface 101 by the direct printing device 108 described in connection with FIG. 1a. In the first print pass, the ink mist extraction unit 106 can be deactivated or switched off, so that the first print line 111 corresponds to a reference print line.

After application of the first print line 111, a second print pass can be provided to activate the ink mist extraction unit 106 and apply a second print line 112 to the container surface 101, without any relative movement between the container surface 101 and the printing nozzle row 105 of the direct printing device 108 having taken place between the first and second print passes. Consequently, only due to the air flow caused by the ink mist extraction unit 106, the second print line 112 is displaced by a value Ax 114 with respect to the second print line 112 depending on the printing position.

In a next step, the control unit can determine the model of the print deviation according to one of the previously discussed embodiments based on an image of the first and second print lines 111, 112 applied to the container surface 101 recorded by the recognition device.

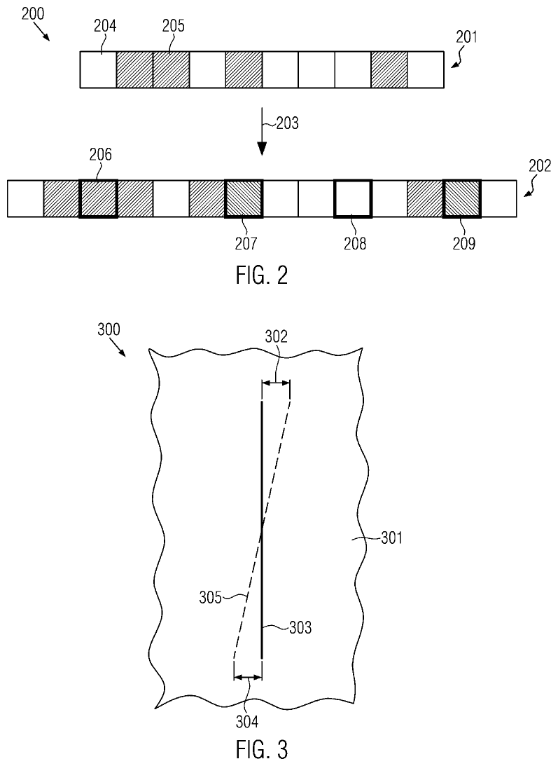

An embodiment of a further method according to the disclosure for printing on an irregular container is shown in connection with FIG. 2.

In the embodiment described here, it is provided according to the disclosure that at least one pixel line with a pixel number n of a print template for a print image based on a shape of a surface region of an irregular container is extended by a pixel number m and the information contained in the original pixel line is scaled to the extended pixel line. Based on the at least one extended pixel line, a corrected print template is generated and based on the corrected print template, the print image is applied to the surface region of the irregular container by means of a direct printing device having a plurality of printing nozzles.

An irregular container is to be understood as a container whose surface deviates from an ideal shape, for example a cylindrical shape. This includes, for example, a container whose surface is at least partially conical in shape, such as a container with a cylindrical base body and a conical shoulder region. Containers whose container surface (the geometric shape of the entire container surface is considered) is at least partially round, angular, conical or elliptical can also be understood as irregular containers. In addition, containers provided with embossing or debossing can also be classified as irregular containers.

With respect to possible designs of the direct printing device, reference is made here to the embodiment of the direct printing device 108 described in connection with FIG. 1a. As also already described in connection with FIG. 1a, the direct printing device 108 can comprise a control unit that is designed to carry out the method steps according to the disclosure described above.

In the embodiment of a pixel line extension 200 discussed in connection with FIG. 2, a pixel line 201 of a print template is shown, which comprises ten pixels. In the embodiment discussed here, the pixel row 201 can be a row of pixels arranged along a horizontal direction of the print template. Alternatively, it can also be a row of pixels arranged vertically in the print template or along any other direction in the print template. Each of the ten pixels represents image information, wherein a pixel in the embodiment shown here represents either a white pixel 204 or a black pixel 205.

Based on a shape of a container surface onto which the pixel line 201 of the print template is to be printed, the control unit can extend the pixel line 201 by a certain number of pixels m∈ [symbol] (m=4 in the example shown) in step 203. The number of pixels m by which the pixel line 201 is extended and also the pixel positions 206, 207, 208 and 209 at which the additional pixels are inserted into the extended pixel line 202 can be selected in particular based on the shape of the container surface to which the pixel line is to be applied.

For example, the area content of the container surface to be printed on (for example, an embossing) can be compared with the area content of the assigned ideal shape (for example, cylindrical shape). From the relationship of the area contents, it can then be derived how many more pixels m need to be added in order to achieve a resolution of the print image on the container surface that is similar to the resolution on a container surface with an ideal shape or deviates from it by a maximum of 5% or 10%.

The shape of the container surface is to be understood as a three-dimensional structure of the container surface, which can be described, for example, by coordinates of a plurality of container surface positions.

By extending the original pixel line 201 to the extended pixel line 202 and creating a corrected print template, distortions caused in particular by an irregular container surface, which would have occurred when applying the print image based on the print template with the original pixel line 201, can be compensated for or prevented.

In the embodiment shown here, four additional pixels are inserted into the extended pixel line 202 at positions 206, 207, 208 and 209 based on a shape of the container surface to be printed on.

In the embodiment described in connection with FIG. 2, the image information of the added pixels 206, 207, 208 and 209 is determined based on the image information of the two adjacent pixels in the original pixel line 201 between which the additional pixels in the extended pixel line 202 have been inserted. In the embodiment shown here, the color value of the inserted pixels 206, 207, 208, 209 was determined by interpolating the color values of the two adjacent pixels in the original pixel line 201, between which the pixel for the extension was inserted. For example, the two adjacent pixels of the inserted pixel 206 are black, so that the interpolated color value of the pixel 206 is also black. The adjacent pixels of the pixel 207 are in turn black and white, so that the color value of the interpolated pixel 207 corresponds to a mixture of black and white and thus a gray color value. The two adjacent pixels of the pixel 208 are in turn white, so that the interpolated pixel 208 is also displayed as a white pixel. In contrast, the adjacent pixels of the pixel 209 are white and black, so that interpolation of the color values of the two adjacent pixels results in a gray color value for the pixel 209.

This embodiment is for explanatory purposes only, but does not limit the disclosure. Generally, a color value (or other parameter) of the pixel 206, 207, 208, 209 to be added can be obtained by averaging the corresponding parameters of adjacent pixels in one or two dimensions, wherein the adjacent pixels can comprise nearest neighbors of the pixel to be added and/or next-but-one neighbors of the pixel to be added.

By extending the pixel line 201 by a certain number of the pixels 206, 207, 208, 209 and by inserting such pixels at certain pixel positions of the extended pixel line 202 based on a shape of a surface of the printing container, a corrected print template can be created. When the printing nozzles are controlled by the control unit based on the corrected print template, compensation can be achieved for distortions in the print image caused by the irregular shape of the container or the shape of the surface of the irregular container, thus improving the quality of the print image applied to an irregular container.

The embodiment described in connection with FIG. 2 is to be understood as exemplary. Thus, the pixel line 201 can also comprise any other number of pixels. Furthermore, the extended pixel line 202 can also be extended by any other number of pixels, wherein the pixels can also be inserted at any other position of the extended pixel line 202. In an alternative embodiment, the pixels of the pixel rows can also represent colors, for example, and the pixels inserted in the extended print template can represent interpolated color values.

The embodiment described in connection with FIG. 2 can be combined with the embodiment of FIG. 1.

A further embodiment of a method according to the disclosure for generating a corrected print template for printing on a container is shown in connection with FIG. 3.

According to the disclosure, it is provided that a pixel offset is determined for at least one pixel of a print template for a print image based on an offset of a first printing nozzle arranged on one side of a direct printing head comprising printing nozzles and a second printing nozzle arranged on an opposite side of the direct printing head with respect to a print plane, a corrected print template is generated based on the determined pixel offset and the print image is applied to the container by means of the direct printing device based on the corrected print template.

Thus, in particular through tilting or rotating the direct printing head with respect to the print plane, compensation can be achieved for the resulting printing errors in the print image applied to the container surface.

With respect to the design of the direct printing device, reference is made to the explanations in connection with FIG. 1a. In particular, the direct printing device can also comprise a control unit that is designed to carry out the method steps according to the disclosure.

FIG. 3 shows a print image 300 applied to a container surface, which was applied, for example, to the surface 101, 301 of a container 102 using the printing nozzle row 105 of the direct printing head 107 described in connection with FIG. 1a.

The print image shown in FIG. 3 comprises a first print line (reference print line) 303, which was applied to the container surface in a certain standard alignment by means of the direct printing head 107. A second print line 305 is also shown, wherein the direct printing head 107 is rotated by an angle α with respect to the standard alignment upon the application of such second print line 305. Rotation means a rotation of the printing head in a print plane that is perpendicular to the directions along which the ink drops 103 have been ejected from the printing nozzles 104 of the direct printing head 107 to generate the print line 303 on the container surface 101, 301.

The rotation of the printing head upon application of the second print line 305 leads to a corresponding rotation of the second print line 305 relative to the first print line 303 and thus to an offset 302 between a print dot of the first and second print lines applied by the first printing nozzle of the direct printing device. A corresponding offset between the corresponding print dot of the two print lines 303, 305 can also be observed for the print dot of the first print line 303 and the second print line 305 applied by the second printing nozzle of the direct printing device.

In the embodiment discussed here, the first printing nozzle is arranged at the first outermost end of the printing nozzle row 105 shown in connection with FIG. 1a and the second printing nozzle is arranged on the opposite side of the direct printing head 107 at the other outermost end of the printing nozzle row 105. This arrangement of the first and second printing nozzles is to be understood as exemplary.

In an alternative embodiment, it can also be provided that the first and second printing nozzles are arranged in two end regions of the printing nozzle row 105 on opposite sides of the direct printing head 107, wherein one end region can comprise a certain number of printing nozzles, such as the three outermost or the five outermost printing nozzles of the printing nozzle row. If, for example, the direct printing head 107 comprises a plurality of printing nozzle rows 105, it can also be provided that the first printing nozzle is arranged, for example, in a first printing nozzle row and the second printing nozzle is arranged in a second printing nozzle row, wherein the two printing nozzle rows can be arranged on opposite sides of the direct printing head.

Based on the determined offset 302, 304, a pixel offset can be determined by the control unit for at least one pixel of the print template, for example, and a corrected print template can be generated based on the determined pixel offset. Based on the corrected print template, the control unit can then control the printing nozzles 104 of the direct printing device 108 in such a way that compensation is achieved for the pixel offset generated by the rotation of the direct printing head and an aligned print image is applied to the container surface 101.

In one embodiment, the pixel offset can be determined based on a number Np of printing nozzles of the direct printing head, an offset V of the print pixel at the uppermost and lowermost position of the print line in units of pixels and the position of the pixel P_{Korr} to be corrected. This enables a precise determination of the pixel offset and thus an exact correction of the misalignment of the print image on the container surface 101, 301 caused by a rotation of the direct printing head 107.

The pixel offset for the at least one pixel of the print template can then be calculated based on the connection

$$Δ P = ( \frac{{P}_{Korr}}{{N}_{D}} V * 2 ) - V ,$$

Based on the pixel offset determined in this way, a corrected pixel position can then be calculated for the at least one pixel position P′=P+ΔP of the print template P and a corrected print template can be generated based on this.

If the printing device is now used to apply a print image to the container surface based on the corrected print template, compensation can be achieved for the error in the print image caused by the rotation, and the quality of the print image generated can be further improved.

The embodiment described in connection with FIG. 3 can be combined with all embodiments described in connection with FIGS. 2 and 3.

Further, for each of the embodiments discussed in connection with FIGS. 1, 2 and 3, it can be provided to divide the print template into individual color layers before determining the pixel offset and to apply the methods according to the previously discussed embodiments or a combination thereof to each of the color layers, so that a corrected print template (also referred to as a color layer print template) is generated for each of the color layers. In order to apply a color print image, for example, a plurality of the direct printing devices shown in connection with FIG. 1a can be arranged one behind the other along the circumference of the container and a color print image based on one of the corrected color layer print templates can be applied to the container surface by each of the printing devices.

1. A direct printing method for printing on a container having a print image by means of a direct printing device comprising a direct printing head with at least one printing nozzle row and an ink mist extraction unit, wherein a pixel offset is determined for at least one pixel of a print template for the print image based on a model for a print deviation from a normal pressure value caused by the ink mist extraction along the print nozzle row, wherein a corrected print template is generated based on the determined pixel offset, wherein the print image is applied to the container by means of the direct printing device based on the corrected print template.

2. The direct printing method according to claim 1, wherein the model of the print deviation is determined based on a maximum print deviation at a position of a printing nozzle row from the normal pressure value, a first print deviation from the normal pressure value at a first printing nozzle arranged at one end of the printing nozzle row and a second print deviation from the normal pressure value at a second printing nozzle arranged at the other end of the printing nozzle row.

3. The direct printing method according to claim 2, wherein, in the event that the maximum print deviation is at a position between the first printing nozzle and the second printing nozzle, the print deviation along the printing nozzle row is determined in a first region of the printing nozzle row by linear interpolation between the first print deviation and the maximum print deviation and in a second region of the printing nozzle row by linear interpolation between the second print deviation and the maximum print deviation.

4. The direct printing method according to claim 1, wherein the pixel offset is determined based on the print deviation model for at least one pixel line of the print template.

5. A direct printing device for printing on a container, comprising a direct printing head having a plurality of printing nozzles, wherein the printing nozzles are arranged in at least one printing nozzle row, an ink mist extraction unit and a control unit, wherein the control unit is designed to carry out the method according to claim 1.

6. The direct printing device according to claim 5, wherein the ink mist extraction unit is arranged on a side surface of the direct printing head.

7. A direct printing method for printing on an irregular container, wherein at least one pixel line with a pixel number n of a print template for a print image based on a shape of a surface region of the irregular container is extended by a pixel number m, wherein the information contained in the original pixel line is scaled to the extended pixel line, wherein a corrected print template is generated based on the at least one extended pixel line, wherein the print image is applied to the surface region of the irregular container by means of a direct printing device having a plurality of printing nozzles based on the corrected print template.

8. The direct printing method according to claim 7, wherein the scaling of the information contained in the original pixel line to the extended pixel line comprises an interpolation between two adjacent pixels of the original pixel line.

9. A direct printing device for printing on an irregular container, comprising a direct printing head having a plurality of printing nozzles, wherein the printing nozzles are arranged in at least one printing nozzle row, and a control unit, wherein the control unit is designed to perform the method according to claim 7.

10. A direct printing method for printing on a container, wherein a pixel offset is determined for at least one pixel of a print template for a print image based on an offset of a first printing nozzle arranged on one side of a direct printing head comprising printing nozzles and a second printing nozzle arranged on an opposite side of the direct printing head with respect to a print plane, wherein a corrected print template is generated based on the determined pixel offset, wherein the print image is applied to the container by means of the direct printing device based on the corrected print template.

11. The direct printing method according to claim 10, wherein the printing nozzles of the direct printing head are arranged in at least one printing nozzle row and the pixel offset is determined based on an offset of a first printing nozzle arranged at one end of a printing nozzle row and a second printing nozzle arranged at the other end of the printing nozzle row with respect to the print plane and/or wherein the pixel offset is determined based on an offset between a first printing nozzle of a first printing nozzle row arranged at one end of the direct printing head and a second printing nozzle of a second printing nozzle row arranged at the other end of the direct printing head with respect to the print plane.

12. The direct printing method according to claim 10, wherein the pixel offset is determined based on the maximum number of printing nozzles of the direct printing head and the position of the pixel.

13. A direct printing device for printing on a container, comprising a direct printing head having a plurality of printing nozzles, wherein the printing nozzles are arranged in at least one printing nozzle row, and a control unit, wherein the control unit is designed to carry out the method according to claim 11.

14. The direct printing method according to claim 1, wherein the print template is divided into different color layers and a corrected print template is created for each color layer.
